(19) United States
(12) Patent Application Publication
(10) Pub. No.: US 2016/0353012 A1
(43) Pub. Date: Dec. 1, 2016

(54) ZOOMING CONTROL METHOD FOR CAMERA AND ELECTRONIC APPARATUS WITH CAMERA

(71) Applicant: HTC Corporation, Taoyuan City (TW)

(72) Inventors: Yih-Feng KAO, TAOYUAN CITY (TW); Ruey-Jer CHANG, TAOYUAN CITY (TW); Lun-Cheng CHU, TAOYUAN CITY (TW); Wei-Chung YANG, TAOYUAN CITY (TW)

(21) Appl. No.: 14/720,965

(22) Filed: May 25, 2015

(51) Int. Cl. H04N 5/232

(52) U.S. Cl. CPC H04N 5/23216; H04N 5/23238; H04N 5/23296; H04N 5/23293

(57) ABSTRACT

A zooming control method is disclosed to perform following operations. A graphical user interface is displayed, and the graphical user interface includes a preview image corresponding to the zooming scale of the camera. A user input is received to assign the zooming scale for zooming in or zooming out the camera. The camera is natively capable of adopting the zooming scale within a scalable range between a wide bound and a telephoto bound. In response to a determination that the zooming scale assigned by the user input is wider than the wide bound of the scalable range, a panorama view mode is launched on the graphical user interface. The preview image during the panorama view mode is generated by the camera adopting the zooming scale at the wide bound, displayed within a central part on the graphical user interface and surrounded by a blank area on the graphical user interface.

### FIELD OF INVENTION

The disclosure relates to a photography method and a user interface thereof. More particularly, the disclosure relates to a method and a user interface for controlling a zooming function of a camera

### BACKGROUND

Photography used to be a professional job, because it requires much knowledge in order to determine suitable configurations (e.g., controlling an exposure time, a white balance, a focal distance) for shooting a photo properly. As complexity of manual configurations of photography has increased, required operations and background knowledge of user have increased.

A focal length is an important factor while shooting a photo. For example, the focal length affects a field-of-view (FOV) of the photo. In other words, the focal length affects what shows in the photo and how large the items are within the photo. While shooting with a fixed focal length (FFL) lens, the focal length is fixed, such that the user must move his camera to chance the size of the items within the photo. On the other hand, while shooting with zoom lens, the focal length can be adjusted manually by the user or automatically by an auto focus system to shoot the photo in different scale. For example, when the target object is far from the user, the user can zoom in the camera to capture the photo around a telephoto end of a zooming scale. When the target object is close to the user or the target object is tall/big/large in size, the user can zoom out the camera to fit the target object into the photo around a wide end of the zooming scale.

A scalable range of the zooming scale is limited by structures and capabilities of the zoom lens. In general, the zoom lens requires a mechanical assembly of lens elements for which the focal length (and thus angle of view) can be varied. Zoom lenses are often described by the ratio of their longest to shortest focal lengths. For example, a zoom lens with focal lengths ranging from 100 mm to 400 mm may be described as a 4:1 or “4×” zoom. The zoom lens may occupy larger space when the zooming capability is increased, e.g., up to “10×” zoom. The zoom lens is limited by size on a mobile device, and it is hard to implement a high zooming ratio lens on a compact-sized mobile device. In general, a maximal field-of-view and a largest telephoto ratio of the camera are limited by a wide bound and a telephoto bound corresponding to the zooming capability of the camera.

### SUMMARY

An aspect of the disclosure is to provide a non-transitory computer accessible memory medium, which includes program instructions for controlling an electronic apparatus with a camera. The program instructions are executable by a processor to perform following operations. A graphical user interface is displayed, and the graphical user interface includes a preview image corresponding to the zooming scale of the camera. A user input is received to assign the zooming scale for zooming in or zooming out the camera. The camera is natively capable of adopting the zooming scale within a scalable range between a wide bound and a telephoto bound. In response to a determination that the zooming scale assigned by the user input is wider than the wide bound of the scalable range, a panorama view mode is launched on the graphical user interface. The preview image during the panorama view mode is generated by the camera adopting the zooming scale at the wide bound, displayed within a central part on the graphical user interface and surrounded by a blank area on the graphical user interface.

Another aspect of the disclosure is to provide a computer-method for controlling an electronic apparatus with a camera.. The computer-implemented method includes following operations. Plural mode thresholds are set. A zooming scale is determined in accordance with a user input. In response to a relationship between the zooming scale assigned by the user input and the mode thresholds, the camera is configured into one of operational modes correspondingly. In response to that the zooming scale assigned by the user input is out of a scalable range of the camera and is wider than a wide bound of the scalable range, a panorama shooting, mode of the camera is launched, a serial of images are captured in sequence by the camera toward different directions of view during the panorama shooting mode, and the serial of images are at least partially overlapped.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact the dimensions of the various features may be arbitrarily increased or reduced for clarity of discussion.

FIG. 1, which is a schematic diagram illustrating the operations performed by the program instructions according to an embodiment of the disclosure.

FIG. 2A and FIG. 2B are schematic diagrams illustrating an electronic apparatus with a camera according to an embodiment of the disclosure.

FIG. 3A to FIG. 3E are schematic diagrams illustrating contents shown on a graphical user interface of the electronic apparatus under different zooming scale.

FIG. 3F is a schematic diagram illustrating the panorama guiding system on the graphical user interface during the panorama view mode according to an embodiment of the disclosure.

FIG. 4 is a schematic diagram illustrating details of the zoom scroller according to an embodiment of the disclosure.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting, in addition, the present disclosure may repeat reference numerals and/or letters in the various examples. This repetition is for the purpose of simplicity and clarity and does not in itself dictate a relationship between the various embodiments and/or configurations discussed.

An embodiment of the disclosure is related to how to control a camera. In some embodiments, the camera is able to zoom in or zoom out to a specific zooming scale, such that the user can decide what will show in an image captured by the camera. For example, when the target object is far from the user, the user can zoom in the camera to capture the photo around a telephoto end of the zooming scale. When the target object is close to the user or the target object is tall/big/large in size, the user can zoom out the camera to fit the target object into the photo around a wide end of the zooming scale.

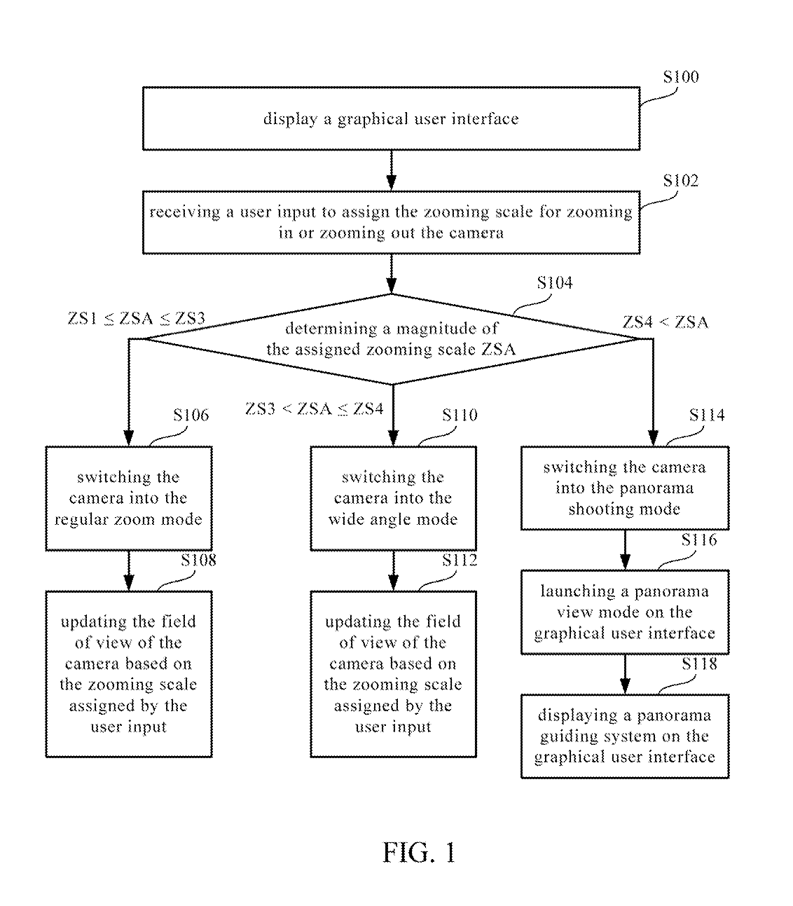

An embodiment of the disclosure is a non-transitory computer accessible memory medium, which includes program instructions for controlling an electronic apparatus with a camera. The program instructions are executable by a processor to perform some operations. Reference is made to FIG. 1, which is a schematic diagram illustrating the operations performed by the program instructions according to an embodiment of the disclosure.

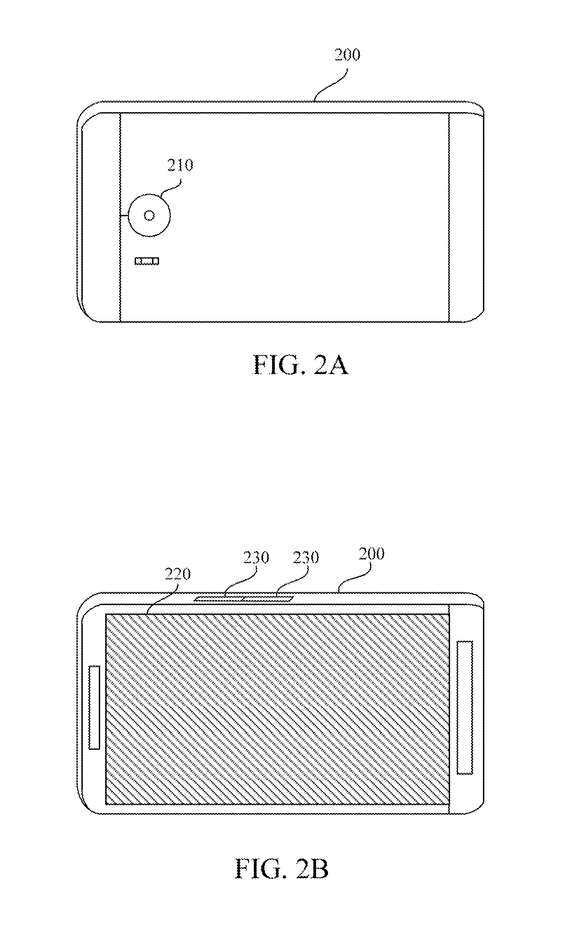

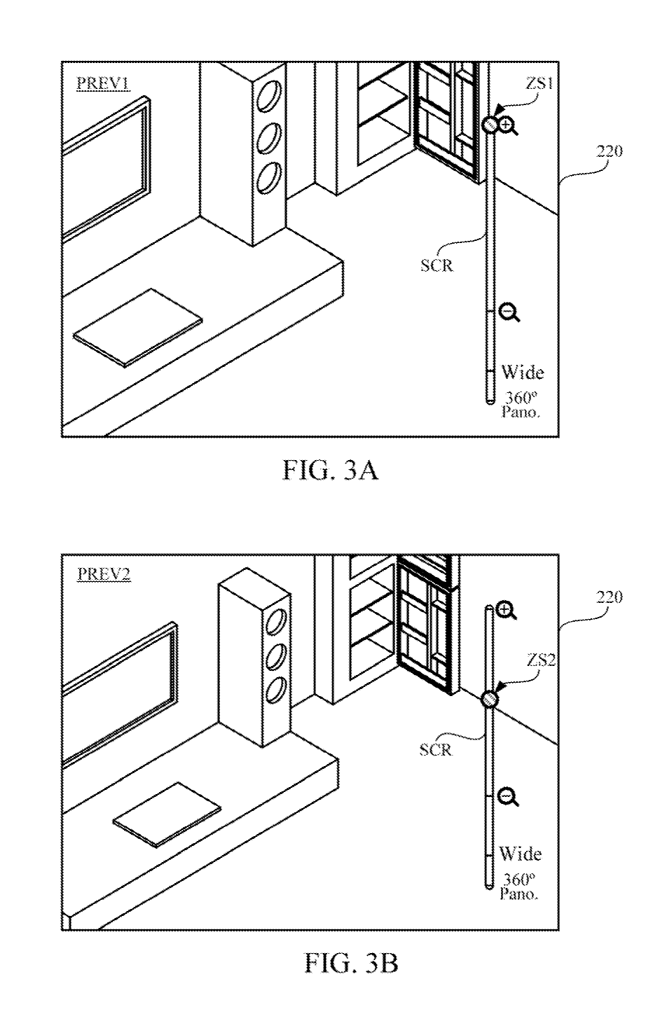

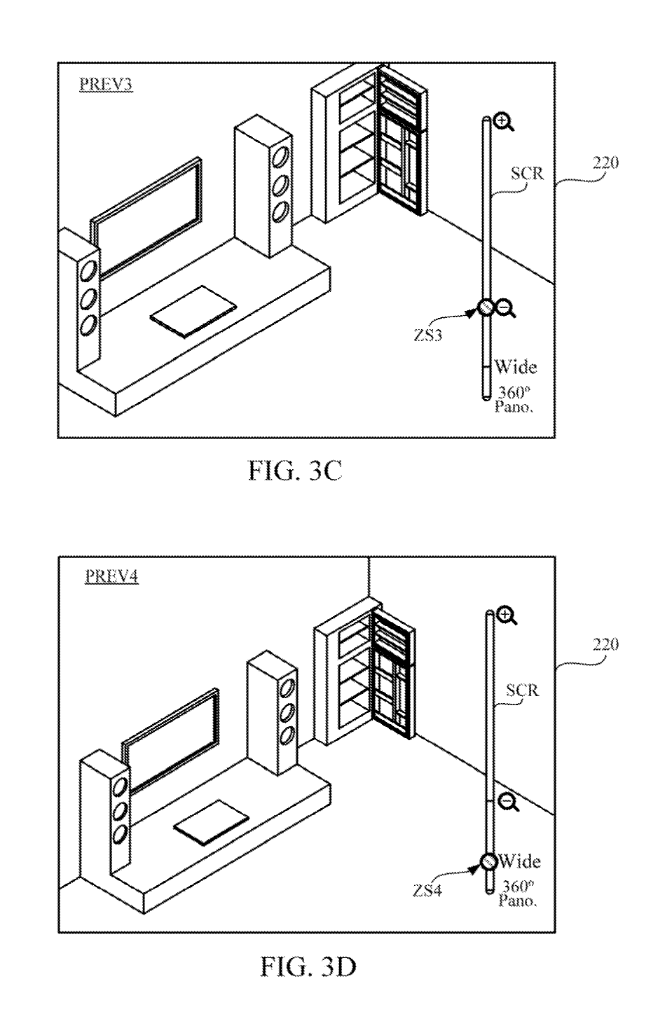

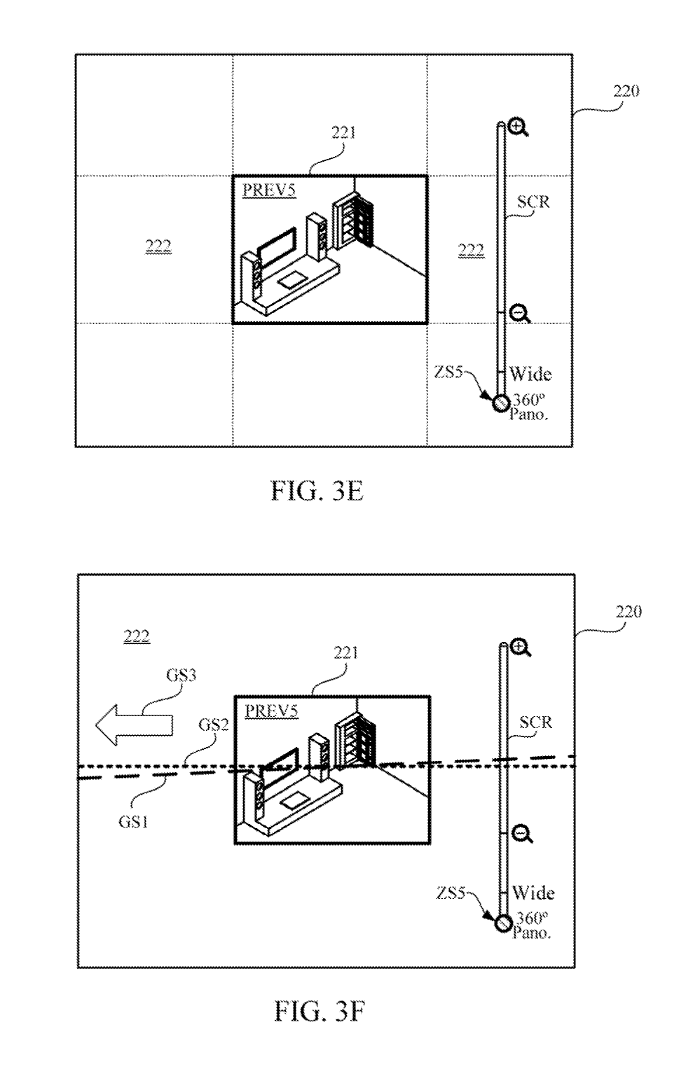

As shown in FIG. 1, the operation S100 is executed for displaying a graphical user interface, which includes a preview image corresponding to the zooming scale of the camera. Reference is also made to FIG. 2A, FIG. 2B, FIG. 3A, FIG. 3B, FIG. 3C, FIG. 3D and FIG. 3E, FIG. 2A and FIG. 2B are schematic diagrams illustrating an electronic apparatus 200 with a camera 210 according to an embodiment of the disclosure. FIG. 3A to FIG. 3E are schematic diagrams illustrating, contents (including the preview image PREV1˜PREV5) shown on a graphical user interface 220 of the electronic apparatus 200 (as shown in FIG. 2) under different zooming scale ZS1˜ZS5. The graphical user interface 220 is displayed on a display panel of the electronic apparatus 200 in this embodiment shown in FIG. 2B. The preview images PREV1˜PREV5 corresponding to different zooming scales ZS1˜ZS5 of the camera 210 are reflected on the graphical user interface 220 in FIG. 3A to FIG. 3E.

As shown in FIG. 1 the operation S102 is executed for receiving a user input to assign the zooming scale ZSA for zooming in or zooming out the camera 210. In the embodiment, the camera 210 is natively capable of adopting the zooming scale within a scalable range between a wide bound and a telephoto bound. In this embodiment, the display panel (e.g., the graphical user interface 220 shown in FIG. 2B) is integrated with a touch sensor to form a touch screen, such that the user can perform a touch gesture on the touch screen. The touch screen can sense the touch gesture as the user input.

In an example, when the user puts two fingers on the touch screen and slides these two fingers inward toward each other (also called as a pinch-in gesture), the zooming scale is assigned to be wider than its original value and the camera 210 is triggered to zoom out. In another example, when the user puts two fingers on the touch screen and slides these two fingers outward from each other (also called as a pinch-out gesture), the zooming scale is assigned to be wider than its original value and the camera 210 is triggered to zoom in.

The user input of the disclosure is not limited to the touch gesture. In some embodiments, the user can also adjust the zooming scale ZSA by manipulating specific function keys 230 as shown in FIG. 2B. As shown in FIG. 2B, the specific function keys 230 include a volume-up key and a volume-down key for configuring, the audio volume. For example, the user can zoom out the camera 210 by pressing the volume-down key, and zoom in the camera 210 by the volume-up key. In addition, a zoom scroller SCR is displayed on the graphical user interface 220 as shown in FIG. 3A˜FIG. 3E along the preview image. The user can zoom out the camera 210 by dragging a movable indictor along the zoom scroller SCR, such that the zooming scale ZSA is assigned accordingly. Therefore, there are many input manners, e,g., touch gestures (pinching-in, pinching-out, dragging over the zoom scroller SCR) and functional keys (pressing the volume-down/volume-up keys) tin assigning the zooming scale ZSA the embodiment.

As Shown in FIG. 1, the operation S104 is executed for determining a magnitude of the assigned zooming scale ZSA. Then, the program instructions switch the electronic apparatus 200 into different modes according to the magnitude of the assigned zooming scale ZSA. In this embodiment, the camera 210 is capable to operate under a plurality of operational modes. The operational modes in the embodiment include a regular zoom mode, a wide angle mode and a panorama shooting mode. However, the disclosure is not limited to at three operational modes. In some other embodiments, the operational modes of the camera 210 may only include the regular zoom mode and a panorama shooting mode (w/o the wide angle mode). Or in some other embodiment, the camera 210 may include more than three operational modes, e.g., a telephoto mode, a mid-range mode, a macro mode, a wide-angle mode, a panorama shooting mode, etc.

In the embodiment, in response to a determination that the assigned zooming scale ZSA is between the zooming scale ZS1 and the zooming scale ZS3, the operation S106 is executed for switching the camera 210 into a regular zoom mode, and the operation S108 is executed for updating a field-of-view of the preview image based on the zooming scale assigned by the user input. The assigned zooming scale ZSA of the camera 210 corresponds to a field-of-view (FOV) of the preview image, the field-of-view is wider when the camera 210 is zoomed out, and the field-of-view is narrower when the camera 210 is zoomed in.

As shown in FIG. 3A, the zooming scale ZSA is assigned at ZS1, which is the telephoto bound of the scalable range in the embodiment. Therefore, the field-of-view of the preview image PREV1 is narrowest (compared to other preview images PREV2˜PREV4), and items within the preview image PREV1 is larger in size, such that the user can see the items clearly from a distance when the zooming scale ZSA is assigned at ZS1.

The scalable range of the zooming scale is natively limited by structures and capabilities of the zoom lens of the camera 210. In this case, the scalable range is defined by a wide bound (for shooting an image with the widest angle of view) and a telephoto bound (for shooting an image with the maximal magnification/enlargement).

In some embodiments, a zooming feature of the camera includes an optical zoom function and/or a digital zoom function. The optical zoom function is achieved by optical components of the zoom lens implemented on the camera. The optical zoom function cause less loss to the quality of the image. On the other hand, the digital zoom function involves in-camera image processing. When the user utilizes the digital zoom function, the camera enlarges the image area at the center of the frame and trims away the outside edges of the picture. The optical zoom function cause more loss to the quality of the image. Sometimes, a magnification range achieved by the digital zoom function is not regarded as a real scalable range.

When the user zoom in the camera toward the telephoto bound, the camera may utilize the optical zoom function at first to enlarge the items within the image, and then the camera may further utilize the digital zoom function if the user tends to zoom in the camera over the capability of the optical zoom function.

On the other hand, when the user zoom out the camera toward the wide bound, the camera may utilize the optical zoom function to capture the image relative to the widest angle of view that the camera can shoot in one image. However, the digital zoom function is unable to enhance the scalable range at the wide bound. On a conventional electronic apparatus with the camera, the wide bound of the scalable range is fixed and decided by the camera (e.g., the zoom lens of the camera).

It is assumed that the user input for zooming out (e.g., the pinch-in gesture or alike) is received, and the zooming scale ZSA can be modified from ZS1 and assigned at ZS2. As shown in FIG. 3B, the zooming scale ZSA is assigned at ZS2, which is an intermediate zooming, scale between ZS1 (the telephoto bound) and ZS3. The field-of-view of the preview image PREV2 is relatively wider compared to other preview image. PREV1), such that the preview image PREV2 can cover larger visual angle and more items the field-of-view) in the same image.

Similarly, the zooming scale ZSA can be further modified from ZS2 and assigned at ZS3. As shown in FIG. 3C, the zooming scale ZSA is assigned at ZS3, which is a widest zooming scale for the regular zoom mode of the camera 210. In other words, the camera 210 under the regular zoom mode is not able to zoom out over ZS3. In general, the camera 210 with standard zoom lens is about to zoom out to a specific focal length, e.g., a focal length of 35 mm, 28 mm, 24 mm, etc. A maximal FOV of the camera 210 with standard zoom lens is approximately up to 45° in visual angle.

In the embodiment, the camera 210 is able to operate under the wide angle mode. The camera under the wide-angle mode typically have a field-of-view approximately 60°, 70 or even more in visual angle. In some embodiment, the wide-angle mode can be achieved by adopting a wide-angle lens, a fisheye lens, or a. macro lens on the camera 210.

In this embodiment, if the user zooms out the camera 210 from the telephoto end and approach to the zooming scale ZS3, which is the widest zooming scale for the regular zoom mode of the camera 210, the zooming function will be stopped and paused at the zooming scale ZS3 once. Then, if the user keeps zooming out the camera 210, the zooming scale ZSA can be further modified beyond ZS3, and the camera 210 is switched into the wide angle mode. In this embodiment, the zooming scale ZS3 is considered as the wide angle threshold.

As shown in FIG. 1 and FIG. 3D, in response to a determination that the zooming scale is assigned between the wide angle threshold (i.e., ZS3) and the wide bound (i.e., ZS4), the operation S110 is executed for switching the camera 210 into the wide angle mode, and the operation S112 is executed for updating a field-of-view of the preview image based on the zooming scale assigned by the user input.

When the zooming scale ZSA is assigned between the wide angle threshold (i.e., ZS3) and the wide bound (i.e.. ZS4), as shown in FIG. 3D the zooming scale ZSA is set at ZS4, the preview image PREV4 has the field-of-view wider than any of the preview images PREV1˜PREV3 in the regular zoom mode. The wide view mode allows the user to capture as much view in the scene within the capability of the camera 210. In this embodiment, the zooming scale ZS4 is the wide bound of the scalable range according to the capability of the camera 210. However, sometimes the user needs to shoot an image with a FOV even wider than the capability of the camera 210 (i.e., wider than the wide bound of the scalable range).

In this embodiment, if the user zooms out the camera 210 from the telephoto end and approach to the zooming scale ZS4, which is the widest zooming scale within the capability of the camera 210, the zooming function will be stopped and paused at the zooming scale ZS4 once. Then, if the user keeps zooming out the camera 210, the zooming scale ZSA can be further modified beyond ZS4, and the camera 210 is switched into the panorama shooting mode. In this embodiment, the zooming scale ZS4 is considered as the wide bound of the scalable range.

As shown in FIG. 1 and FIG. 3E, in response to a determination that the zooming scale assigned by the user input is out of the scalable range (ZS1 to ZS4 in the embodiment) of the camera 210 and wider than the wide bound (i.e.. ZS4) of the scalable range, the operation S114 is executed for switching the camera 210 into the panorama shooting mode. In this case, the camera 210 is configured to adopt the zooming scale ZS4 at the wide wound of the scalable range, because the zooming scale ZS4 is the widest zooming scale which the camera 210 is capable of. For the user interface, the operation S116 is executed for launching a panorama view mode on the graphical user interface 220. As shown in FIG. 3E, in the panorama view mode, the preview image PREV5 is generated by the camera 210 adopting the zooming scale at the wide bound, displayed within a central part 221 on the graphical user interface 220 and surrounded by a blank area 222 on the graphical user interface.

The contents of the preview image PREN5 shown in FIG. 3E is similar to the contents of the preview image PREV4 shown in FIG. 3D. In the panorama view mode, the preview image PREV5 can be generated by shrinking the preview image PREV4 proportionally (e.g., by a digital image processor of the electronic apparatus 200) and fitting the result into the central part 221 on the graphical user interface 220. The blank area 222 indicates that the camera 210 is zoomed out over the scalable range, and the panorama shooting mode of the camera 210 is activated right now.

In some embodiments, a proportion between the central part 221 and the blank area 222 is fixed, such as 1:8 (referring to FIG. 3E), 1:4 or 1:2, etc.

In some other embodiments, the proportion between the central part 221 and the blank area 222 is also dynamically determined in accordance with the zooming scale ZSA assigned by the user input. For example, the central part 221 is relatively larger when the zooming scale ZSA is wider; on the other hand, the central part 221 is relatively smaller when the zooming scale ZSA is narrower, such that the graphical user interface 220 can reflect the user interactively for zooming in or zooming out even that the zooming scale ZSA is outside the scalable range (ZS1 to ZS4 in the embodiment).

When the panorama view mode is displayed on the graphical user interface 220, it is configured to prompt the user to move the electronic apparatus 200 with the camera 210 horizontally or vertically to capture a serial of images in sequence by the camera 210. The serial of images are captured toward different directions of view during the panorama shooting mode, and the serial of images are at least partially overlapped, such that the serial of images can be stitched into one continuous panorama photo.

As shown in FIG. 1 and FIG. 3E, the operation S118 is executed for displaying a panorama guiding system on the graphical user interface 220 during the panorama view mode. Reference is further made to FIG. 3F, which illustrates the panorama guiding system on the graphical user interface 220 during the panorama view mode according to an embodiment of the disclosure.

As shown in FIG. 3F, the panorama guiding system includes a first reference line GS1 corresponding to the horizon, a second reference line GS2 corresponding to a current level of the camera 210, and a moving indictor GS3. During the panorama view mode, the first reference line GS1 and the second reference line GS2 are utilized to notify the user whether the camera 210 is move properly along the horizontal level. The moving indictor GS3 is utilized to notify the user a proposed moving direction. However, the moving indictor GS3 is not limited to point to the left side. In some other embodiments, the moving indictor can also point toward the top side, the down side and/or the right side. The model of the panorama guiding system shown in FIG. 3F is for demonstration. However, the disclosure is not limited thereto. The panorama guiding system in some embodiments further includes more information, such as an icon indicating hand-shaking, an icon indicating a target position for the next image, etc.

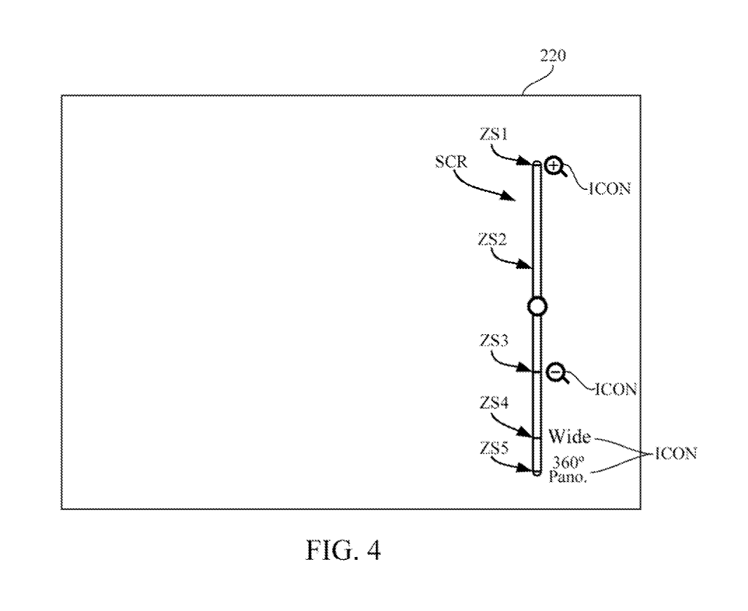

Furthermore, in each of the operational modes mentioned in aforesaid embodiments as shown in FIG. 3A to FIG. 3F, the zoom scroller SCR is displayed on the graphical user interface 220 along with the preview image PREV1˜PREV5. Reference is also made to FIG. 4, which is a schematic diagram illustrating details of the zoom stroller SCR according to an embodiment of the disclosure. As shown in FIG. 4, the zoom scroller SCR is utilized to show a current state of the zooming scale, and also acknowledge the user about the scalable range of the camera 210.

As shown in FIG. 3A to FIG. 3F, there are icons displayed along the zoom scroller SCR in sequence corresponding to the telephoto bound (i.e., the zooming scale ZS1 in aforesaid embodiment), the wide angle threshold (i.e., the zooming scale ZS3 in aforesaid embodiment) and the wide bound (i.e., the zooming scale ZS4 in aforesaid embodiment).

Based on aforesaid embodiments, when the user keeps zooming out the camera 210 over the scalable range and the zooming scale ZSA assigned by the user input is wider than the wide bound ZS4, the camera 210 is automatically switched into the panorama shooting mode, and the panorama view mode is launched on the graphical user interface 220. Therefore, the user has more flexibility to adjust the zooming scale ZSA without limited by the scalable range. It also saves the time for the user to manually switch the shooting mode from a standard shooting mode into the panorama view mode.

In this document, the term “coupled” may also be termed as “electrically coupled”, and the term “connected” may be termed as “electrically connected”. “coupled” and “connected” may also be used to indicate that two or more elements. cooperate or interact with each other. It will be understood that, although the terms “first,” “second,” etc., may be used herein to describe various elements, these elements should not be limited by these terms. These terms are used to distinguish one element from another. For example, a first element could be termed a second element, and, similarly, a second element could be termed a first element, without departing from the scope of the embodiments. As used herein, the term “and/or” includes any and all combinations of one or more of the associated listed items.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A non-transitory computer accessible memory medium comprising program instructions for controlling an electronic apparatus with a camera, wherein the program instructions are executable by a processor to:
display a graphical user interface comprising a preview image corresponding to the zooming scale of the camera;
receive a user input to assign the zooming scale for zooming in or zooming out the camera, wherein the camera is natively capable of adopting the zooming scale within a scalable range between a wide bound and a telephoto bound; and
in response to a determination that the zooming scale assigned by the user input, is wider than the wide bound of the scalable range, launch a panorama view mode on the graphical user interface, wherein the preview image during the panorama view mode is generated by the camera adopting the zooming scale at the wide bound, displayed within a central part on the graphical user interface and surrounded by a blank area on the graphical user interface.

2. The memory medium of claim 1, wherein the camera is further capable to operate under a regular zoom mode and a wide angle mode, a wide angle threshold is configured between the wide bound and the telephoto bound, the program instructions are further executable to:
in response to a determination that the zooming scale is assigned between the telephoto bound and the wide angle threshold, switch the camera into the regular zoom mode and update a field-of-view of the preview image based on the zooming scale assigned by the user input; and
in response to a determination that the zooming scale is assigned between the wide angle threshold and the wide bound, switch the camera into the wide angle mode and update a field-of-view of the preview image based on the zooming scale assigned by the user input.

3. The memory medium of claim 2, wherein the program instructions are further executable to:
display a zoom scroller on the graphical use interface; and
display a plurality of icons along the zoom scroller in sequence corresponding to the telephoto bound, the wide angle threshold and the wide bound.

4. The memory medium of claim 1, wherein the zooming scale of the camera corresponds to a field-of-view (FOV) of the preview image, the field-of-view is wider when the camera is zoomed out, and the field-of-view is narrower when the camera is zoomed in.

5. The memory medium of claim 1, wherein a proportion between the central part and the blank area is determined in accordance with the zooming scale, the central part is relatively larger when the zooming scale is wider, and the central part is relatively smaller when the zooming scale is narrower.

6. The memory medium of claim 1, wherein in response to that the panorama view mode is launched, the program instructions are further executable to:
display a panorama guiding system on the graphical user interface for guiding a moving pattern of the camera during the panorama view mode.

7. The memory medium of claim 6, wherein the panorama guiding system comprises a moving indictor, a first reference line corresponding to the horizon, and a second reference line corresponding to a current level of the camera.

8. The memory medium of claim 1, wherein the scalable range between the wide bound and the telephoto bound is provided by an optical zoom function or a digital zoom function of the camera.

9. A computer-implemented method for controlling an electronic apparatus with a camera, the computer-implemented method comprising:
setting a plurality of mode thresholds;
determining a zooming scale in accordance with a user input; and
in response to a relationship between the zooming scale assigned by the user input and the mode thresholds, configuring the camera into one of the plurality of operational modes correspondingly,
wherein, in response to that the zooming scale assigned by the user input is out of a scalable range of the camera and is wider than a wide bound of the scalable range, a panorama shooting mode of the camera is launched, a serial of images are captured in sequence by the camera toward different directions of view during the panorama shooting mode, and the serial of images are at least partially overlapped.

10. The computer-implemented method of claim 9, wherein the operational modes comprises a regular zoom mode, a wide angle mode and the panorama shooting mode, a wide angle threshold is configured between the wide bound and a telephoto bound of the scalable range, the computer-implemented method further comprises:
in response to a determination that the zooming scale is assigned between the telephoto bound and the wide angle threshold, switching the camera into the regular zoom mode and update the field-of-view of the preview image based on the zooming scale assigned by the user input; and
in response to a determination that the zooming scale is assigned between the wide angle threshold and the wide bound, switching the camera into the wide angle mode and update the field-of-view of the preview image based on the zooming scale assigned by be user input.

11. The computer-implemented method of claim 9, wherein the zooming scale of the camera corresponds to a field-of-view (FOV) of an image captured by the camera, the field-of-view is wider when the camera is zoomed out, and the field-of-view is narrower when the camera is zoomed in.

12. The computer-implemented method of claim 9, wherein the scalable range is provided by an optical zoom function or a digital zoom function of the camera.
